(19) United States
(12) Patent Application Publication
(10) Pub. No.: US 2012/0152983 A1
(43) Pub. Date: Jun. 21, 2012

(54) HOUSEHOLD APPLIANCE HAVING ICE WATER DISPENSER

(75) Inventors: Mehmet Savan, Tekirdag (TR); Nilhan Sevgi, Tekirdag (TR); Tolga Yegin, Izmir (TR)

(73) Assignee: BSH Bosch und Siemens Hausgerate GmbH, Munich (DE)

(21) Appl. No.: 13/300,694

(22) Filed: Nov. 21, 2011

(30) Foreign Application Priority Data
Dec. 15, 2010 (TR) 2010/10473

(51) Int. Cl. B67D 7/84

(52) U.S. Cl. 222/173

(57) ABSTRACT

A refrigerator having an ice water dispenser either with an overlap frame or flush frame. Said ice water dispenser has a dispenser inner sheet and dispenser outer body onto which a dispenser face cover sheet is attached by means of lateral rips. Said dispenser face cover sheet is fixed to cover the periphery of said outer body with respective openings for buttons.

### BACKGROUND OF THE INVENTION

The present invention relates to an electrical household appliance and in particular to a refrigerator's ice water dispenser.

The present invention relates to an electrical household appliance having an ice water dispenser for conveniently serving ice and water as is the case for many advanced category refrigerators.

The ice water dispenser according to the present invention features a set of properties to ensure both a more pleasing visual appearance and a more robust mechanical connection in between the components of said dispenser.

To this end, the existing ice water dispenser is modified such that it is more reliable in terms of mechanical stability and more appealing on the part of users.

On the other hand, a more appealing visual appearance is obtained by way of replacing plastic contours of the ice water dispenser with a metallic look body.

### BRIEF SUMMARY OF THE INVENTION

The most prominent object of the present invention is to provide an ice water dispenser having a more robust mechanical connection in between its components.

Another object of the present invention is to provide an ice water dispenser more reliable in terms of mechanical stability.

The present invention provides a refrigerator having an ice water dispenser either with an overlap frame or flush frame. Said ice water dispenser has a dispenser inner sheet and dispenser outer body onto which a dispenser face cover sheet is attached by means of lateral rips. Said dispenser face cover sheet is fixed to cover the periphery of said outer body with respective openings for buttons.

### BRIEF DESCRIPTION OF THE DRAWINGS

The figures whose brief explanations are herewith provided are solely intended for providing a better understanding of the present invention and are as such not intended to define the scope of protection or the context in which said scope is interpreted in the absence of the description. To this end,

FIG. 1a and 1b demonstrate front and rear perspective views of an overlap frame for an ice water dispenser according to the present invention.

FIGS. 2a and 2b demonstrate front and rear perspective views of a flush frame for an ice water dispenser according to the present invention.

FIG. 3a demonstrates a perspective view of the dispenser body and FIG. 3a demonstrates a perspective view of a dispenser body with a dispenser face cover sheet according to the present invention.

FIGS. 4a and 4b demonstrate enlarged views of the upper parts of the dispenser given in FIGS. 3a and 3b.

FIG. 5 demonstrates a perspective view of the dispenser body with the dispenser face cover sheet according to the present invention.

FIG. 6 demonstrates enlarged views of the upper parts of the dispenser given in FIG. 5.

FIG. 7 demonstrates a perspective view of the dispenser face cover sheet alone according to the present invention.

FIG. 8 demonstrates a perspective view of the dispenser body with the dispenser inner sheet connection detail according to the present invention.

FIG. 9 demonstrates a perspective enlarged view of the dispenser body with the dispenser inner sheet connection detail according to the present invention.

FIG. 10 demonstrates the relationship between said dispenser outer body and said dispenser inner sheet at the middle section according to the present invention.

### DETAILED DESCRIPTION OF EXEMPLARY EMBODIMENTS OF THE PRESENT INVENTION

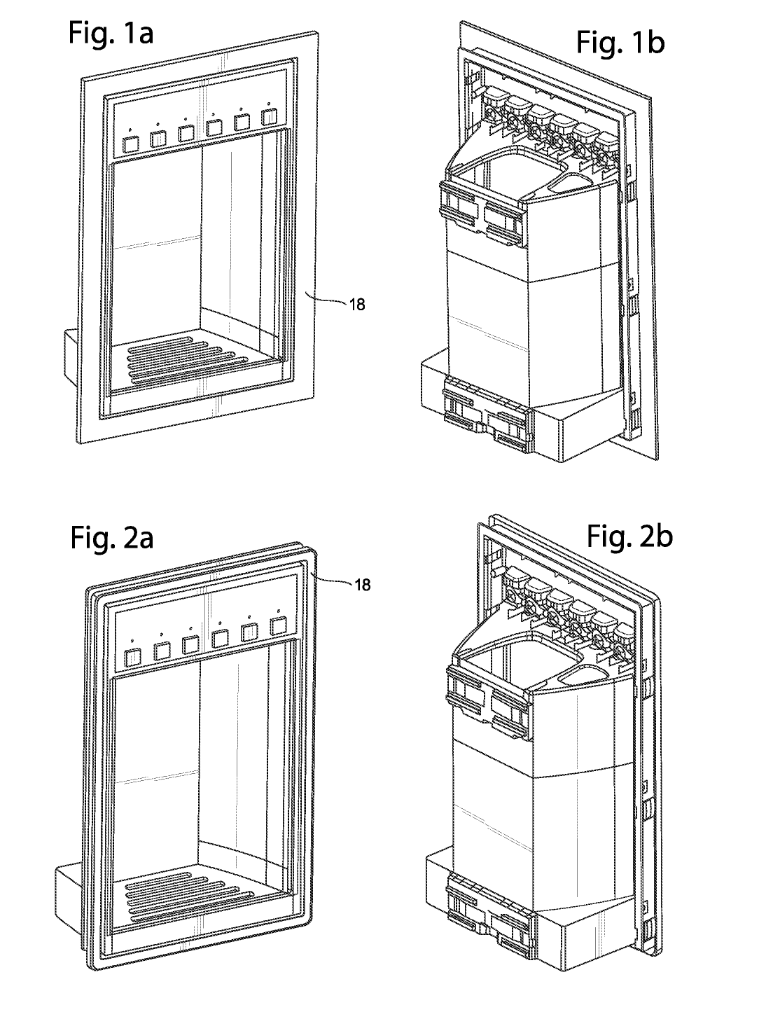

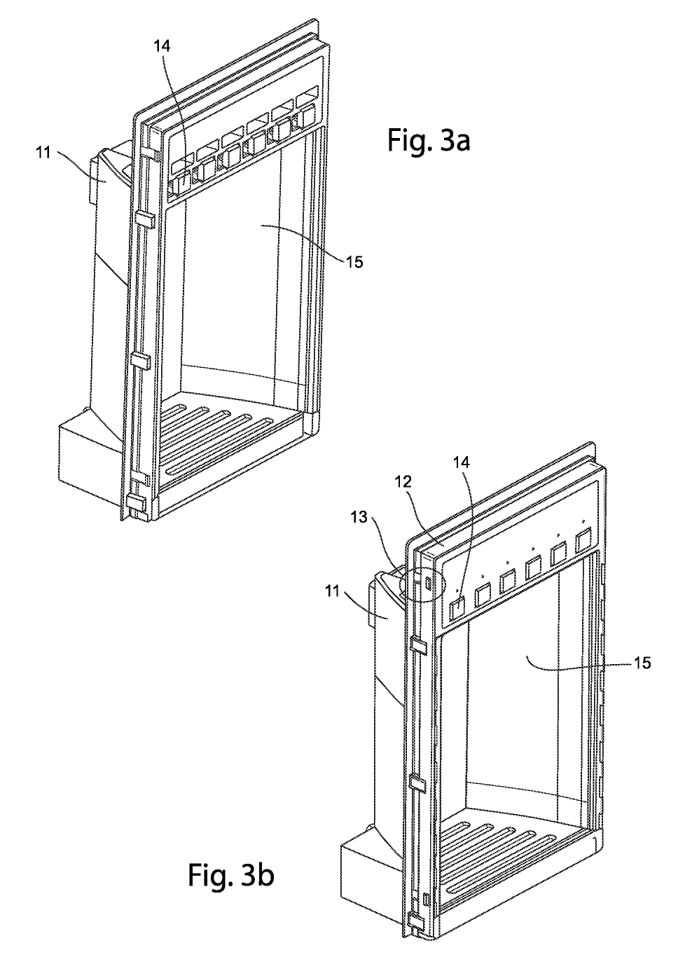

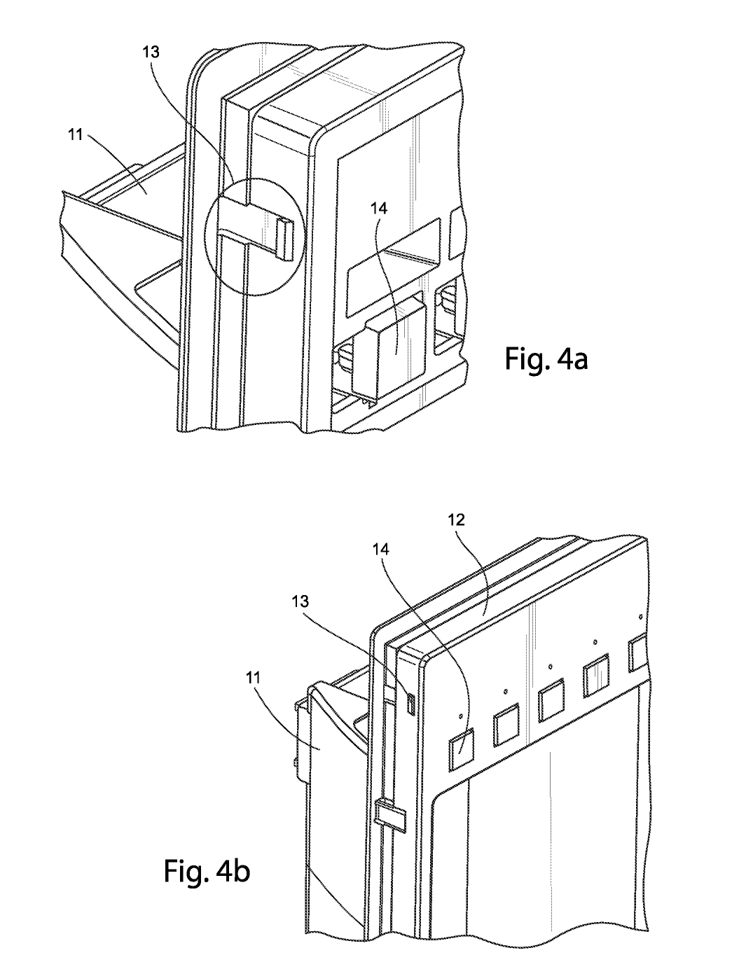

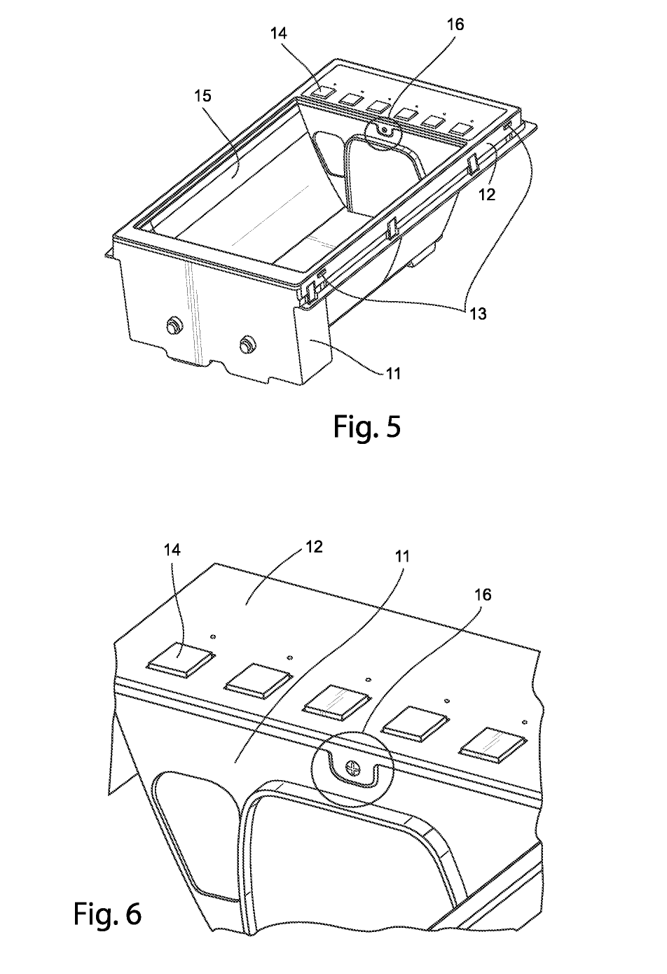

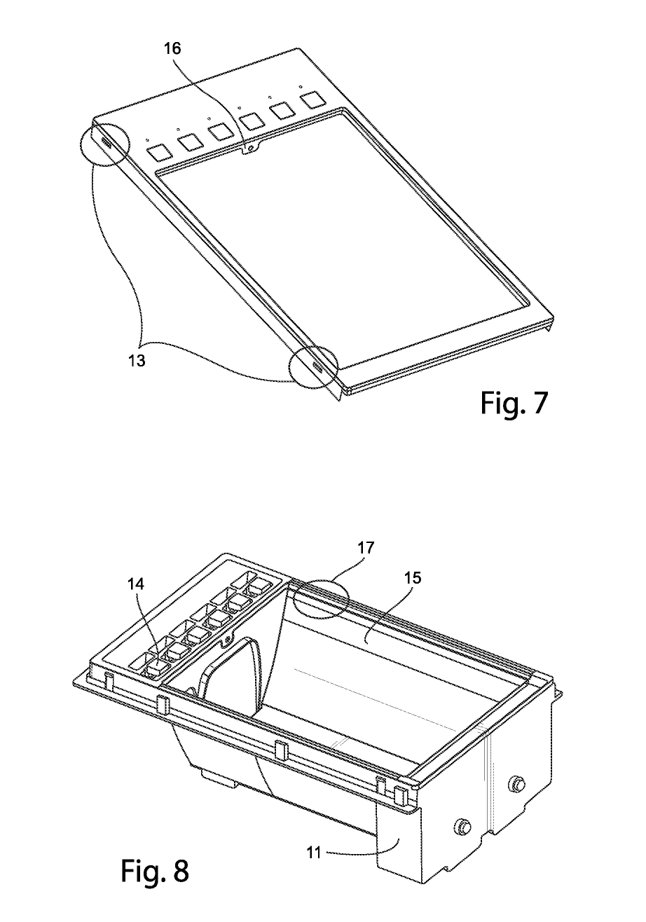

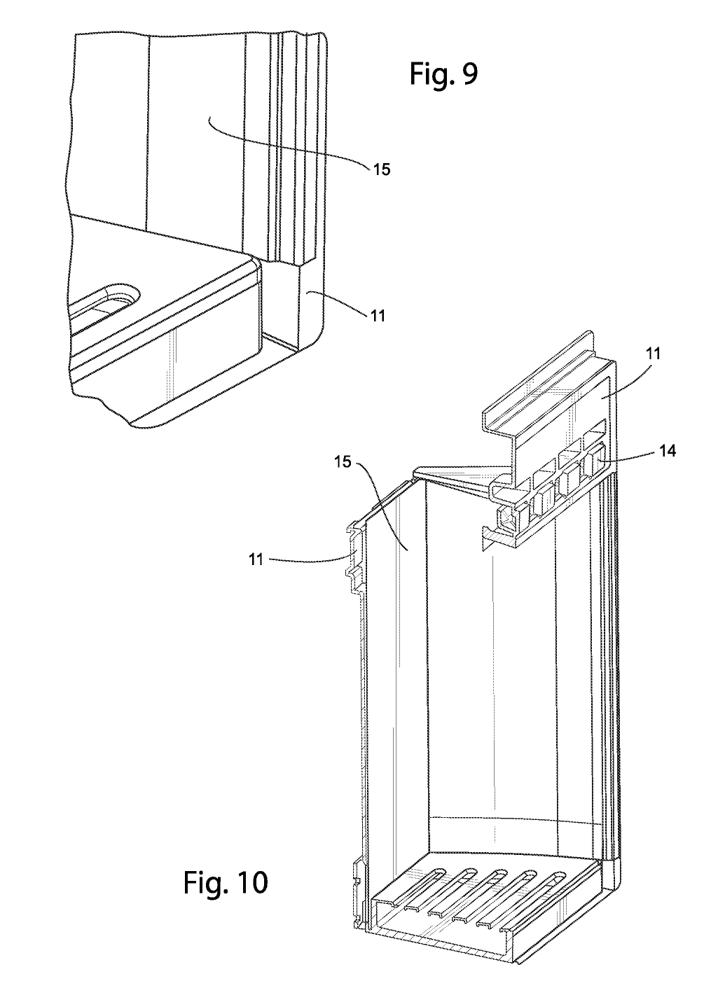

The present invention proposes an electrical household appliance and more particularly a refrigerator having an ice water dispenser. The ice water dispenser is designed either with an overlap frame or flush frame as seen in respectively FIGS. 1 and 2.

Said ice water dispenser has a dispenser inner sheet (15) and dispenser outer body (11) onto which a dispenser face cover sheet (12) is attached by means of lateral rips (13). Said dispenser face cover sheet (12) is fixed to cover the periphery of said outer body (11) with respective openings for buttons (14).

Said dispenser face cover sheet (12) is fixed to said dispenser outer body (11) by means of a screw (16). To this end, displacement of said dispenser face cover sheet (12) in longitudinal and transversal axes of said dispenser outer body (11) is prevented and a secure connection is established.

According to the present invention, said dispenser outer body (11) and said dispenser inner sheet (15) are connected to each other by means of an S-form cross-section inter-engaging connection (17). This S-form cross-section inter-engaging connection (17) provides secure connection of said dispenser outer body (11) with said dispenser inner sheet (15) at both sides along the longitudinal edges of said dispenser outer body (11). FIG. 10 represents the relationship between said dispenser outer body (11) and said dispenser inner sheet (15) at the middle section where there is a clearance of 1 mm in between said outer body (11) and said inner sheet (15).

In the case of flush or overlay frames, an acrylic based double-sided adhesive strip (not shown) is applied on the dispenser surface. FIG. 1a and 2a respectively demonstrate the overlay and flush frames fixed on the double-sided adhesive strips.

In a nutshell, the present invention provides an ice water dispenser having a dispenser inner sheet (15) for covering an inner region of said dispenser delimited by a front part including the front peripheral region thereof and a dispenser outer body (11) onto which a dispenser face cover sheet (12) is attached such that the periphery of said outer body (11) is covered with openings for serving operation buttons (14), said ice water dispenser also having a flush or overlay frame (18) covering said front peripheral region.

1. An ice water dispenser having a dispenser inner sheet for covering an inner region of said dispenser delimited by a front part including the front peripheral region thereof and a dispenser outer body onto which a dispenser face cover sheet is attached such that the periphery of said outer body is covered with openings for serving operation buttons, said ice water dispenser also having a flush or overlay frame covering said front peripheral region.

2. An ice water dispenser as set forth in claim 1 wherein said dispenser face cover sheet is attached to said dispenser outer body by means of lateral rips.

3. An ice water dispenser as set forth in claim 1 wherein said dispenser face cover sheet is fixed to said dispenser outer body by means of a screw displacement of said dispenser face cover sheet in longitudinal and transversal axes of said dispenser outer body is prevented.

4. An ice water dispenser as set forth in claim 1 wherein said dispenser outer body and said dispenser inner sheet are connected to each other by means of an S-form cross-section inter-engaging connection.

5. An ice water dispenser as set forth in claim 4 wherein said S-form cross-section inter-engaging connection provides connection of said dispenser outer body with said dispenser inner sheet at two sides along the longitudinal edges of said dispenser outer body.

6. An ice water dispenser as set forth in claim 4 wherein said dispenser outer body and said dispenser inner sheet's relationship at the middle section is such that there is a clearance of 1 mm in between said outer body and said inner sheet at the middle section.

7. An ice water dispenser as set forth in claim 1 wherein said flush or overlay frames are attached on the front peripheral region of said dispenser outer body by means of an acrylic based double-sided adhesive strip.
